(19) United States
(12) Patent Application Publication
(10) Pub. No.: US 2016/0072842 A1
(43) Pub. Date: Mar. 10, 2016

(54) MAINTAINING RULE COHERENCY FOR APPLICATIONS

(71) Applicants: Gary S. GREENBAUM, Mercer Island, WA (US); Rahul AGARWAL, Bellevue, WA (US)

(72) Inventors: Gary S GREENBAUM, Mercer Island, WA (US); Rahul AGARWAL, Bellevue, WA (US)

(21) Appl. No.: 14/778,488

(22) PCT Filed: Mar. 18, 2014
(86) PCT No.: PCT/US14/31123

§ 371 Date: Sep. 18, 2015

Related U.S. Application Data
(60) Provisional application No. 61/802,889, filed on Mar. 18, 2013.

(51) Int. Cl. H04L 29/06; H04W 88/16

(52) U.S. Cl. CPC H04L 63/20; H04W 88/16; H04L 63/102

(57) ABSTRACT

The disclose describes a system and method for maintaining network access rules for device applications using a state graph of the device application. A rules update agent generates a state graph by recursively exercising internal state transitions and recording network locations of a corresponding resource server associated with the state transition. The internal states of the application are reflected as nodes in the state graph. A rule list is generated from the state graph to identify which states have access to which resource servers. The rules update agent is also configured to dynamically generate a truncated state graph from which a transitory rule list is generated.

### RELATED APPLICATIONS

This application claims priority under 35 U.S.C. Section 119(e) to U.S. Provisional Application Ser. No. 61/802,889, filed Mar. 18, 2013 entitled “Maintaining Access Rule Coherency for Dynamic Applications,” the disclosure of which is incorporated by reference herein in its entirety.

### BACKGROUND

In order to facilitate network traffic between computing devices on disparate networks, a gateway server is positioned between the networks. The gateway server uses access policies to determine whether data can be exchanged between the computing devices on the disparate networks. For example, the gateway server uses the access policies to determine whether an application on a first network has the necessary permissions to access resources on a second remote network. The access policies may be defined by outside agents (e.g., network operators, application developers, content providers, and the like). These access policies need to be translated into network rules that are then used by the gateway server in makings its access determinations. Once the access policies are translated into network rules, the network rules remain static, unless updated manually in a non-real time nature.

Because resource server locations change and data needs of the applications change over time, it is desirable to update and/or confirm the network rules used by the gateway server, even though the policy may remain the same. The existing techniques for maintaining network rules are cumbersome and inefficient, and are not able to handle the demands of dynamic applications, such as social apps and the like. The rule coherency technique described in the present disclosure overcomes these shortcomings and provides a scaleable solution for dynamically generating the network rules for both static applications and dynamic applications.

### SUMMARY

Embodiments of the disclosure are directed towards a system configured to maintain rule coherency for an application. A state graph is generated based on a policy applicable to an application. The state graph has several nodes and transitions from one node to another node. Each node is associated with one state of the application and each transition represents a change from one node to the next. A rule list is generated based on the state graph. The rule list identifies an address for a corresponding external resource server associated with each transition and specifies which of the states have permission to access which external resource servers. The state graph may be generated in an offline manner or dynamically as a user interacts with the application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a conceptual overview of a system configured to maintain rule coherency for applications;

FIG. 2 is a system view of functional components for implementing the rule coherency technique in accordance with at least one embodiment of the system illustrated in FIG. 1;

FIG. 3 is a flow diagram of a rule coherency technique suitable for use in the functional components illustrated in FIG. 2;

FIG. 4 is an exemplary representation for a statically defined state graph that is suitable to generate a rule list in accordance with the process illustrated in FIG. 3;

FIG. 5 is a flow diagram of another rule coherency technique suitable for use in the functional components illustrated in FIG. 2;

FIG. 6 is an exemplary representation of a dynamically defined truncated state graph that is suitable to generate a transitory rule list in accordance with the process illustrated in FIG. 5; and

FIG. 7 is a functional block diagram representing a computing device for use in certain implementations of the disclosed embodiments or other embodiments of the components illustrated in FIG. 2.

### DETAILED DESCRIPTION

The following disclosure describes a rule coherency technique that generates rules based on a state graph associated with an application. A rule list is generated from the state graph and represents access permissions based on which state the application is in when the access is requested. Therefore, enforcement of a specific policy may allow access to a specific resource server if the application is in one state, but may deny access to the same resource server if the application is in a different state, depending on the state graph when the rules were generated. Thus, as will be described below, the present rule coherency technique allows content providers the ability to selectively allow access to categories of their content based on the state of the application when the application requests access. For example, this dynamic enforcement of access policies provides autonomous enforcement of a content provider's specified access policies with little or no overhead expense or involvement by the content provider for managing the enforcement of their policies.

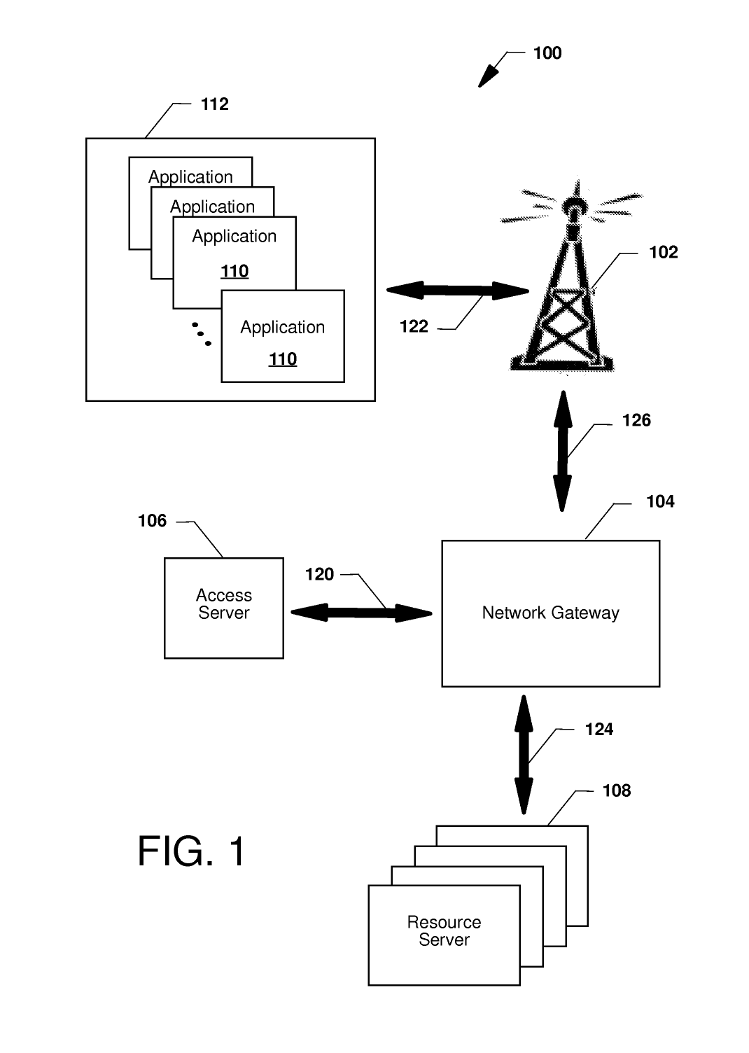

FIG. 1 is a conceptual overview of a system 100 configured to maintain rule coherency for applications. The system 100 includes a physical network 102, a network gateway 104, an access server 106, one or more resource servers 108, and one or more applications 110. The access server 106 is a server remote from a computing device 112 on which the applications 110 are processed. The network gateway 104 communicates with the access server 106 via an access server network 120 and communicates with the physical network via network 126. Both networks 120 and 126 may be heterogeneous networks. The network gateway 104 communicates with the physical network via network 120, The network gateway 104 facilitates data exchanges between a computing device network 122 and a remote resource server network 124. Both the computing device network 122 and the remote resource server network 124 may be heterogeneous networks. For example, computing device network 122 may be a cellular network, a wireless network, a wireless local area network (LAN), and the like. The network configuration uses common configurations known in the art. The network gateway 104 handles the network traffic coming from and going to computing device 112. The network gateway 104 provides common functionality for handling network traffic. In addition, in accordance with the present rule coherency technique, the network gateway 104 translates incoming network protocols to appropriate outbound network protocols and enforces access policies between device applications 110 and remote resource servers 108 using a rule list generated by the access server 106.

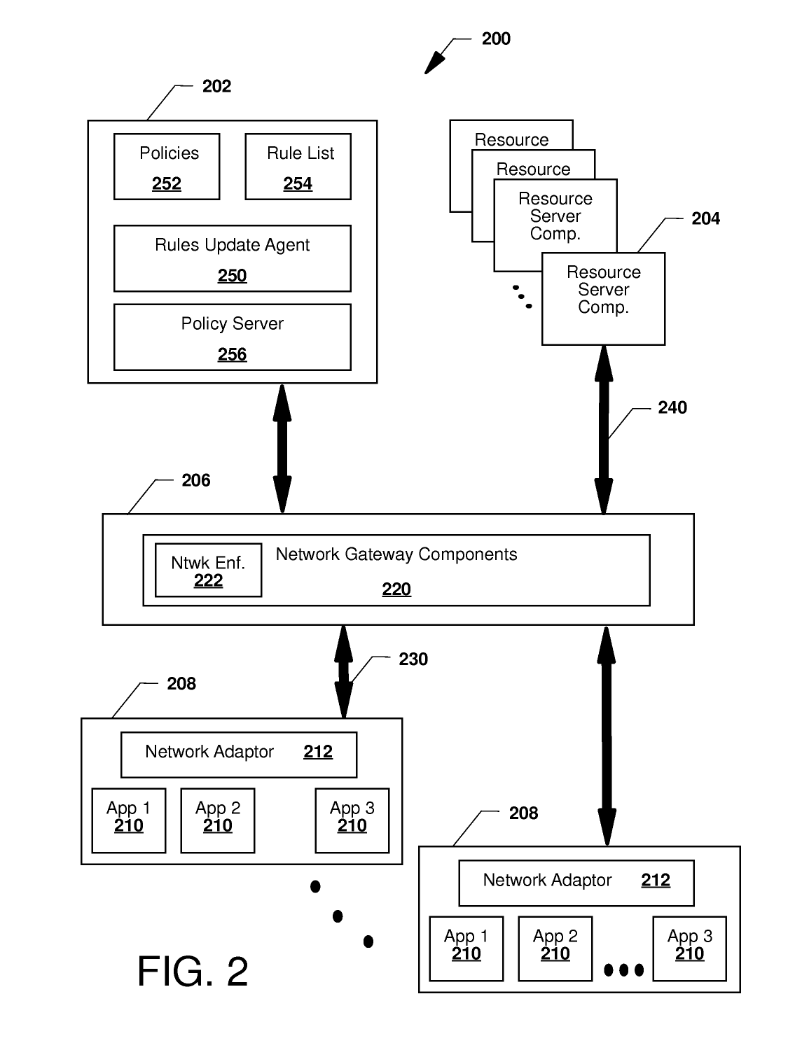

FIG. 2 is a system view of functional components 200 for implementing the rule coherency technique in accordance with at least one embodiment of the system shown in FIG. 1. The functional components 200 include an access server component 202, one or more resource server components 204, a network operator component 206, and one or more device components 208. Each of the device components 208 include one or more device applications 210 and a network adaptor component 212. The network adaptor component 212 enables the device applications 210 to access the resource server components 204 via the network operator component 206. The network operator component 206 includes a network gateway component 220 having a network enforcement component 222. The network gateway component 220 facilitates data exchange between the device application 210 and a resource server component 204 over heterogeneous networks 230 and 240.

The access server component 202 includes a rules update agent 250, access policies 252, a rule list 254, and a policy server component 256. The policy server component 256 communicates the rule list 254 to the network enforcement component 222 in the network gateway component 220. In other embodiments, the access server component 202 may be integrated with the network gateway 104 (shown in FIG. 1).

The data exchanged between device applications 210 and the resource server components 204 traverses the network operator component 206. The network traffic data is intercepted by the network gateway component 220 so that incoming network protocols can be translated into appropriate outbound network protocols and routing information. The network enforcement component 222 is configured to enforce the rule list 254 between the device applications 210 and the resource server components 204.

Access policies 252 may be defined by outside agents, such as a network operator, application developer, content provider, or the like. The access policies 252 describe the access permissions of the device applications 210 to resource server components 204. Access policies 252 may be complex statements that depend on multiple parameters, such as access duration, aggregate data delivery limits, device and end-user content licenses, valid delivery contracts, and the like. The rules update agent 250 is configured to translate the access policies 252 into the rule list 254. For the present rule coherency technique, the rules update agent 250 translates the access policies 252 into the rule list 254 based on a state graph of the application. Therefore, the rules list not only provides a set of a addresses to which the application may access resource servers, but also provides information which the network enforcement component 222 may use to determine whether the application is in a state which would allow access to the resource servers identified in the rule list.

Therefore, in contrast with traditional network rules, commonly referred to as a “whitelist” which indicate the allowed resource servers, the rule list in accordance with the present disclosure is stateful, meaning that the access depends on the state of the application when the access is attempted. Therefore, as will be described in further detail below, enforcement of a specific policy may allow access to a specific resource server if the application is in one state, but may deny access to the same resource server if the application is in a different state. Furthermore, the whitelists used in prior art systems remain static or require updating manually in a non-real time nature. In contrast, the rule coherency technique described in the present disclosure autonomously generates the rule list and updates the rule list without manual intervention. In addition, the rule coherency technique allows enforcement of dynamic applications that change frequently, such as dynamic applications that accommodate new or changing resource servers. As will be described below in detail, the technique generates a transitory rule that supports enforcement of rule coherency for the dynamic application.

As mentioned above, a dynamic application allows users to add or modify links (e.g., external resource services). For example, a social network application may have an access policy that specifies that the application has access to designated content residing on a remote resource server. Because the social network application is a dynamic application which allows users to add and change new links within the application (e.g. add a link to a newspaper), the present rule coherency technique allows the rule list to be updated and customized for each user given the links that are added for that user through the user's interactions with the dynamic application.

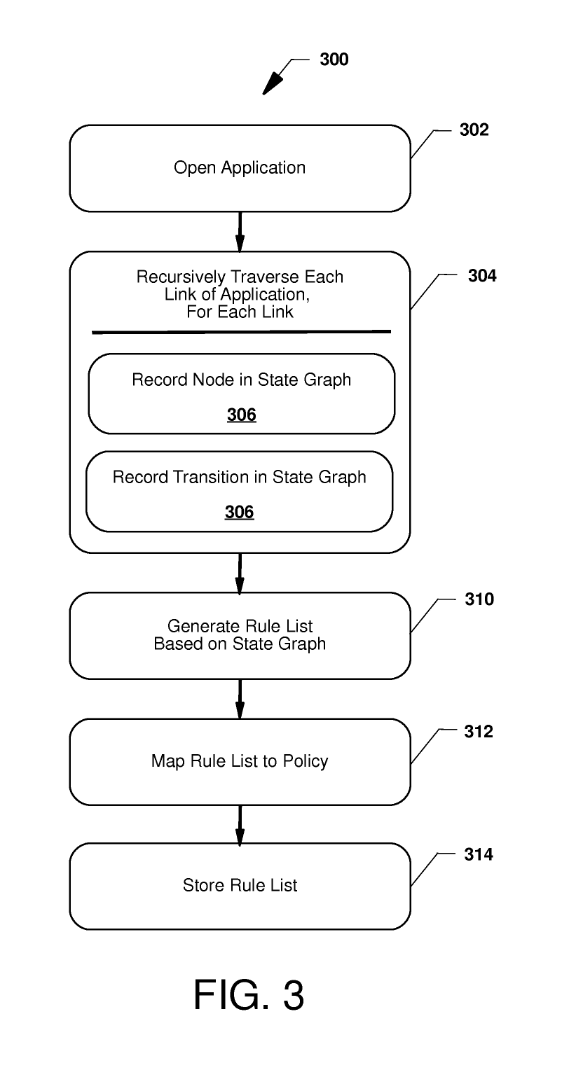

Thus, as will be described in further detail below in conjunction with FIGS. 3-6, in accordance with the rule coherency technique described in the present disclosure, the rules update agent 250 translates the access policies 252 for a given device application 210 into the rule list 254 based on a state graph generated for the application.

While FIG. 2 and the corresponding description describes the interaction between several components, it can be appreciated that such components can include additional components or the functionality described for one component can be combined with another component without departing from the claimed invention. Thus, the described functionality of the components can be implemented using various permutations and combinations of components.

Before describing the various embodiments for a rule coherency technique suitable for use in the access server described in the present disclosure, an overview of the concept is provided. For static applications, the rule list is derived from a state graph of the application that is generated by the access server from policies applicable to the application. The state graph of the application denotes the possible states that the application may transition during operation. The states include internal state and external state transitions. The internal state transitions represent transitions to states that occur in response to end-user responses, such as an end-user response to an application query. For many applications, the internal state space may be bounded. However, even if the internal state space may be bounded, external states representing transitions to states that occur independently of a user's response may occur. Examples of these transitions include a flux of data requests handled by a load balancer managing the assignment of resource servers for a particular application data request.

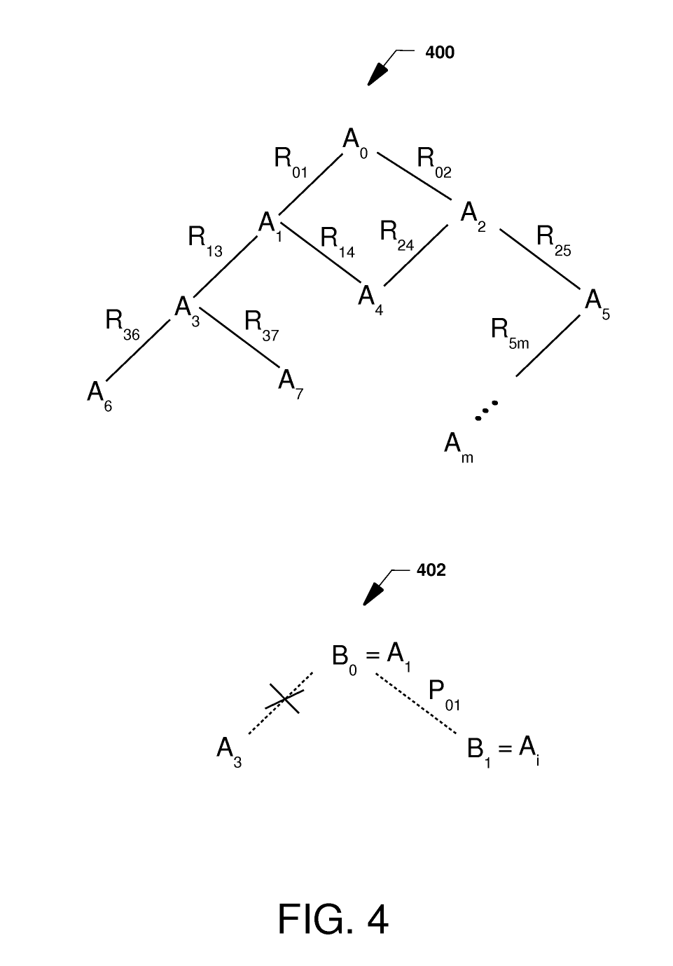

In other applications (hereinafter referred to as dynamic applications), the internal state space may be unbounded, such as when the application has non-deterministic sources of data located on resource servers not previously associated with the device application. Examples of applications having non-deterministic sources of data include search, communications, social apps, and the like. For example, in social networking applications, external resource links may be constantly added. Various embodiments for a rule coherency technique suitable for use in the access server in accordance with the teaching in the present disclosure may be implemented, FIGS. 3 and 4 illustrate two embodiments.

FIG. 3 is a flow diagram of a rule coherency technique suitable for use in the system illustrated in FIG. 2. Process 300 illustrates the rule coherency technique for generating a static rule list based on enforcement of a given access policy. In overview, the rule list specifies an addressable location for external resources that the device application is allowed to access and specifies the states from which the application is allowed to access the external resources using their respective addresses. The address may be implemented using any addressing scheme, such as uniform resource locator (URL), IP address, media access control (MAC) address, and the like. The network gateway then enforces the rules in the rule list based on a current state of the application so that the application can not access links without having the proper permission given the current state of the application. Process 300 may be used for device applications having a bounded internal and external state spaces without any external state spaces.

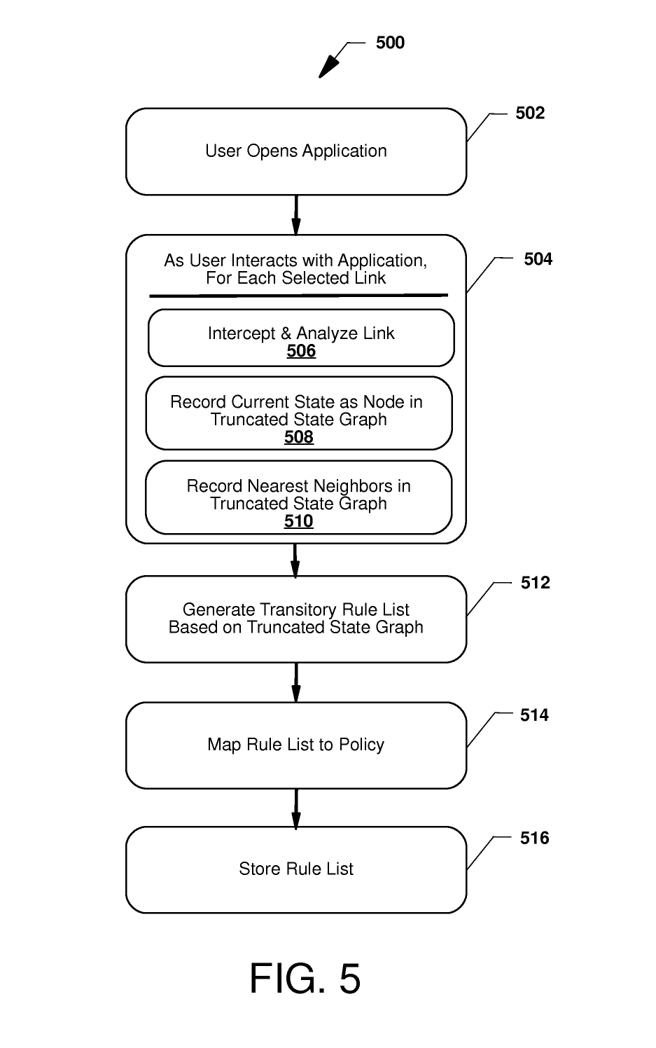

While both the traditional whitelists and the rule list generated by process 300 are used to determine access permissions, the manner in which the rule list is generated and the manner in which the rule list is used to determine access permissions is considerably different. These differences will be described below in conjunction with FIG. 3 for a static type application and then in FIG. 5 for a dynamic application. Process 300 will now be described.

At block 302, an application is selected for execution. During execution a rule list will be generated for a specific policy. Those skilled in the art will appreciate that multiple rule lists may be generated, each rule list being mapped to a different policy applicable to the application. For process 300, the application has a bounded internal state space without any external state space dependencies. Thus, the rule list that is generated can be used for any user who is interacting with the application associated with the specific policy.

At block 304, each external link referenced by the application is evaluated, i.e. network traversed. Traversing each link may be performed by recursively traversing each external link referenced by the application. The recursion may use any well known approach. In addition, other methods of traversing each link of the application may be performed without departing from the scope of the claimed invention.

At block 306, each link that is traversed represents a node in a state graph and the node is recorded in the state graph. Thus, the node represents a state for the application.

At block 308, each transition from one link to the next link represents a transition between two nodes in the state graph. The transition is recorded in the state graph. In other words, the transition represents a change from one node to another node in the state graph and correspondingly, represents a change from one state to another state in the application. In one embodiment, a network location of a resource server is recorded. Thus, the state graph represents multiple nodes to which the application may transition from for each of its internal states. By generating the state graph in this manner, the rule list can then not only specify whether the application has permission to any one of the resource servers that are recorded, but the rule list can provide an even finer granularity by specifying which state of the application has permission to access the resource servers, where one state may have permission and another state may not have permission. This ability to grant permission at a more refined level or lower level than only at an application level provides many advantages.

At block 310, a rule list is generated based on the state graph. The rule list that is generated includes information about the nodes and transitions from the state graph. In other words, the rule lists specifies the possible transitions that are allowed from each node. For example, if a user is at a current state in an application and selects a link, the rule list will either have the transition associated with the link in the rule list or not. If the transition is not in the rule list, the application is not granted permission to proceed to that link. While process 300 illustrates the state graph being generated after completing block 304, block 310 may be performed so that the rule list is incrementally generated as the state graph is created or periodically as the state graph is created or by other timing mechanism, including random generation. The rule list includes an address associated with external resources for which transitions from the current state are allowed. Any addressing scheme may be used, such as URLs, IP addresses, MAC addresses and the like.

At block 312, the rule list is mapped to the specific policy. The specific policy being associated with the application. Thus, for each policy applicable to the application, an associated rule list is generated. The multiple rule lists may remain separate or may be combined without departing from the claimed invention.

At block 314, the rule list may be stored. As illustrated in FIG. 2, the rule list may be output to the network enforcement component in the network gateway. The network enforcement component is then configured to determine which data exchanges to permit between the device application and the resource servers that are on disparate networks using the information in the rule list.

Upon completion of recursively exercising the possible internal states of the application starting from an initial state and ending when the recursive chain self-terminates or is constrained by a policy, process 300 generates a static state graph including the network locations of the resource servers and the allowable transitions between states that abide to the network access policies for the application. Even though the device application for process 300 has a bounded internal state space without any external state space dependencies, process 300 may be continually, periodically, randomly, or otherwise executed so that the rules list is updated and remains coherent with the application. This may be desirable because in certain situations resource servers for a particular application may change due to resource server needs of the application. Therefore, because most modern applications rely on links to external resources that frequently change over time, the rules update agent will perform process 300 to generate updated state graphs, which are translated into updated rule lists. While process 300 could generate the state graph while the user is interacting with the application, for convenience, the embodiment illustrated in FIG. 3 and described above, describes the generation of the state graph while a user is not interacting with the application, i.e. an off-line analysis.

FIG. 4 is an exemplary representation for a statically defined state graph that is suitable to generate a rule list in accordance with the process illustrated in FIG. 3. As described above in conjunction with FIG. 3, process 300 traverses each of the links of an application to determine each of the possible next states to which the application can transition based on a policy and a current state of the application. The state graph 400 depicts an application (e.g., Application A). Application A has various states Aₙ where {n: 0 to m} and A₀ represents an initial state of Application A. Each state (i.e., node) represents a link. Transitions from one state to another state are represented in FIG. 4 as transition R_{i,j} where i represents the starting state and j represents the ending state. Thus, R_{1,2} represents the transition from state A₁ to A₂ (e.g., transition from link 1 to link 2). Transitions R_{i,j} reflect actions taken to get to the next state, which in one embodiment includes the requested resource server's network location. Similarly, state graph 402 depicts an application (e.g., Application B). Application B has various states B₀ B₁ and A₃. One will note that the initial state of Application B (i.e., B₀) corresponds to state A₁ of Application A and state B₁ corresponds to a state in Application A. Transitions from one state to another state in Application B are represented in FIG. 4 as transition P_{i,j} where i represents the starting state and j represents the ending state. The state graphs end when the recursive chain self-terminates (shown at state A₄), assumes a state already recorded (shown at A₆), or is constrained by a policy (represented with an “X” on the transition from B₀ to A₃). As described above, once process 300 has traversed the entire internal application state space, static state graph 400 is completed and contains the network locations of the permitted resource servers that abide with the data requirements and the network access policies for application A. Using the static state graph, a rules list is generated that identifies permitted resource network locations for application A for the policy at each of the states (i.e., nodes). The rules list is represented as union U_{i,j} R_{i,j}. The static state graph 400 may be stored in the access server as a table, a database, or other format. In addition, the rules list may be stored in the access server as a table, a database, or other format for interpretation by the network gateway.

FIG. 5 is a flow diagram of another rule coherency technique suitable for use in the functional components illustrated in FIG. 2. Process 500 illustrates a rule coherency technique for generating a transitory rule list. The transitory rule list exists for a temporary time while the device application is in its current state and is based on the enforcement of an access policy given the current state. Process 500 may be used for applications that have an unbounded internal state space and have external state space dependencies. For these dynamic applications, the process 300 shown in FIG. 3 is unavailable due to the dynamic nature of the application. Therefore, for these types of applications, process 500 analyzes the application's current state and its nearest neighboring states. For applications with unbounded state space, herein referred to as dynamic applications, process 500 is performed realtime as the device application transitions between states.

At block 502, a user selects an application on the user's device for execution by the user's device. The application attempts to obtain services associated with the application. The application may execute in an application container, a browser, or some other mechanism that renders the experience of the application for the user. While the application executes, a user will interact with the application by selecting links to external servers to access the requested application resources.

At block 504, as the user interacts with the application, each selected link is processed. Whether or not the selected link has permission to access an external resource associated with the selected link is determined by obtaining the nearest-neighbor states to which the current state can transition. At the time of selecting the link, the application is in a current state. Therefore, the nearest-neighbor states represent a list of possible transitional states. The list of possible transitional states is determined by reviewing the policy as it applies to the current state. A truncated state graph is used, which represents the current state of the application and the next possible states (i.e., nearest neighbor states). Therefore, each time the user selects a link, a truncated state graph is dynamically generated and a transitory rule list is created based on the truncated state graph. If the selected resource associated with the link is allowed by the transitory rule list, the application transitions to the selected link, thereby transitioning to a new current state.

As one skilled in the art will appreciate, various embodiments for the truncated state graph may be implemented without departing from the scope of the claimed invention. In contrast with process 300 illustrated in FIG. 3, process 500 does not necessarily generate a state graph for each link of the application that can be traversed. Rather, process 500 generates the truncated state graph pertaining to the current state and any possible next states which are allowed by the policy given the current state. By generating a truncated state graph upon each selection of a new link in the application, the present rule coherency technique allows enforcement of policies for dynamic applications. Thus, process 500 is performed dynamically in real time by assessing the requested transition against a transitory rule list based on the specific policy that is being enforced and the truncated state graph for the current state.

At block 506, the selected link generated by the user's interaction with the application is intercepted and analyzed. As illustrated in FIG. 2, for the current embodiment, gateway network components intercept the request and allows the access server component to dynamically generate a state graph and a rule, which is provided to the network enforcement component in order to determine whether the policy permits transitioning from the current state to a new state associated with the selected link. For this embodiment, the state graph is a truncated state graph and the rule list is a transitory rule list. Thus, the analysis is based on the access policy relative to the specific user configuration of the application and on the current state of the application.

At block 508, the current state is recorded as a node in the truncated state graph. One will appreciate that the current state may have already been recorded as one of the possible states from a previous dynamic generation of a prior truncated state graph. While there are multiple variations as to how the truncated state graph is populated, any number of techniques for populating the truncated state graph is envisioned. For example, in another embodiment, process 500 may update and store information regarding the current state and each possible next state and maintain this information in the truncated state graph. In other embodiments, the truncated state graph may be created new for each selected link.

At block 510, the nearest neighbors are recorded in the truncated state graph. The nearest neighbors are determined by applying the policy to the current state. The nearest neighbors represents a list of possible transitional states. Each possible transitional state (i.e., nearest neighbor) is recorded as a node in the truncated state graph. In addition, a transition for each of the nearest neighbors is recorded in the truncated state graph. The transition will be recorded to indicate the action need to change from the current state to the corresponding nearest neighbor states. The transition may be indicate that the transition from the current state to the nearest neighbor state is allowed or is denied based on the specific access policy and the current state of the application. Interestingly, process 500 enforces the specific policy and may determine to allow access to a specific resource server if the application is in one state, but may deny access to the same resource server if the application is in a different state. Process 500 allows content providers the ability to selectively allow access to categories of their content based on the state of the application when it requests the access. This dynamic enforcement of access policies provides autonomous enforcement of the content provider's specified access policies with little or no overhead expense by the content provider for managing the enforcement. As discussed above, the truncated state graph includes the current state and each of the next possible states from which the application's current state can potentially transition. As one skilled in the art will appreciate, the current state may be any state of the application, including the initial state. Therefore, each time the user selects a link, a dynamically truncated state graph is generated or updated in order to determine whether the application has permission to traverse to the selected link, thereby providing rule coherency for dynamic applications as the user interacts with the dynamic application and as the dynamic application dynamically undergoes changes, such as additions of new links and the like.

At block 512, a transitory rule list is generated based on the truncated state graph. In this embodiment, the transitory rule list may be generated after each nearest neighbor is added to the truncated state graph, after all the nearest neighbors have been added, or any time in between. Thus, the transitory rule list that is generated is based on the current dynamic state of the application.

At block 514, the transitory rule list is mapped to the associated policy. One will appreciate that there may be several policies applicable to the application and process 500 is performed for each applicable policy in order to determine if the selected link is allowed or not. The transitory rule list is then provided to the network enforcement component in the network gateway to allow the network enforcement component to either grant permission to the application to transition to the selected link or deny permission. As illustrated in FIG. 2, the transitory rule list, which is a variation of the rule list, may be output to the network enforcement component in the network gateway so that the network enforcement component can determine which data exchanges to permit between the device application and the resource servers that are on disparate networks.

At block 516, the transitory rule list is optionally stored for off-line statistical analysis.

Thus, as described in process 500, in this embodiment the transitory rule list is generated dynamically during user interactions with the device application and as the device application requests external resources.

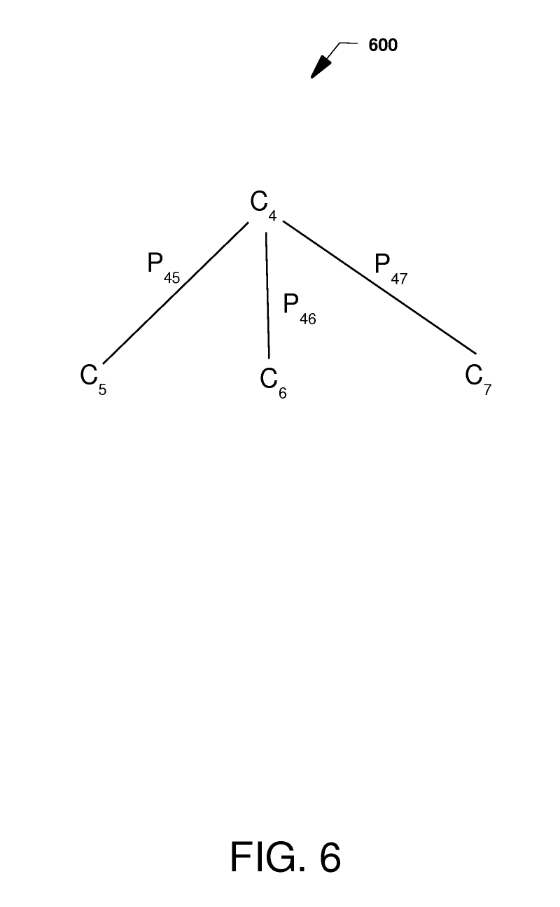

FIG. 6 is an exemplary representation of a dynamically defined truncated state graph that is suitable to generate a transitory rule list in accordance with the process illustrated in FIG. 5. Truncated state graph 600 depicts an application (i.e., Application C) having a current state C₄ and three nearest neighbor states C₅ C₆ C₇, which as described above represent possible transitional states. A transitory rule list is generated from truncated state graph 600. For the application depicted in truncated state graph 600, the transitory rule list would include a rule to transition to each of the possible transitional states. Then, if the requested link is associated with one of these possible states, the application will be granted access to the resource server associated with the selected link. The truncated state graph 600 may be stored in the access server as a table, a database, or other format. In addition, optionally, the transitory rule list may be stored in the access server as a table, a database, or other format. While FIG. 6 illustrates the truncated state graph having three nearest neighbors, one will appreciate that that the number of nearest neighbors is variable and depends on the policy and the current state of the application.

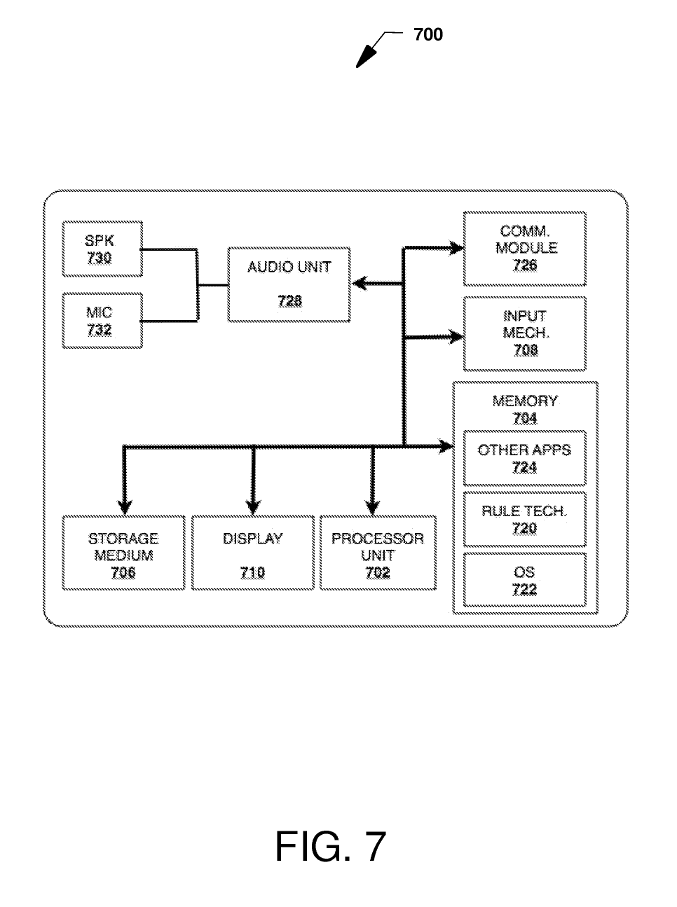

FIG. 7 is a functional block diagram representing a computing device suitable for use in implementations of the rule coherency technique taught in the present application. For example, access server shown in FIG. 2 may be a computing device such as shown in FIG. 7. The computing device 700 includes a processor unit 702, a memory 704, a storage medium 706, an input mechanism 708, and a display 710. The processor unit 702 advantageously includes a microprocessor or a special purpose processor such as a digital signal processor (DSP), but may in the alternative be any conventional form of processor, controller, microcontroller, state machine, or the like.

The processor unit 702 is coupled to the memory 704, which is advantageously implemented as RAM memory holding software instructions that are executed by the processor unit 702. These software instructions represent computer-readable instructions and computer executable instructions. In this embodiment, the software instructions stored in the memory 704 include a rule coherency technique 720, a runtime environment or operating system 722, and one or more other applications 724. The memory 704 may be on-board RAM, or the processor unit 702 and the memory 704 could collectively reside in an ASIC. In an alternate embodiment, the memory 704 could be composed of firmware or flash memory.

The storage medium 706 may be implemented as any nonvolatile memory, such as ROM memory, flash memory, or a magnetic disk drive, just to name a few. The storage medium 706 could also be implemented as a combination of those or other technologies, such as a magnetic disk drive with cache (RAM) memory, or the like. In this particular embodiment, the storage medium 706 is used to store data during periods when the computing device 700 is powered off or without power. The storage medium 706 could be used to store access policies, network rules, state graphs, and the like. It will be appreciated that the functional components may reside on a computer-readable medium and have computer-executable instructions for performing the acts and/or events of the various method of the claimed subject matter. The storage medium being on example of computer-readable medium.

The computing device 700 also includes a communications module 726 that enables bi-directional communication between the computing device 700 and one or more other computing devices. The communications module 726 may include components to enable RF or other wireless communications, such as a cellular telephone network, Bluetooth connection, wireless local area network, or perhaps a wireless wide area network. Alternatively, the communications module 726 may include components to enable land line or hard wired network communications, such as an Ethernet connection, RJ-11 connection, universal serial bus connection, IEEE 1394 (Firewire) connection, or the like. These are intended as non-exhaustive lists and many other alternatives are possible.

The audio unit 728 may be a component of the computing device 700 that is configured to convert signals between analog and digital format. The audio unit 728 is used by the computing device 700 to output sound using a speaker 730 and to receive input signals from a microphone 732. The speaker 732 could also be used to announce incoming calls.

A display 710 is used to output data or information in a graphical form. The display could be any form of display technology, such as LCD, LED, OLED, or the like. The input mechanism 708 includes keypad-style input mechanism and other commonly known input mechanisms. Alternatively, the input mechanism 708 could be incorporated with the display 710, such as the case with a touch-sensitive display device. Other alternatives too numerous to mention are also possible.

As described above, the present application provides an in-network, non-device based software agent to determine network access for device applications and provides an accurate method of calculating network access rules for static applications, and also for highly dynamic applications having external network state dependencies. Thus, the access server enables selective access to remote resources using the non-local rules update agent for translating complex network access policies into actionable network rules. Because the present rule coherency technique does not reside on the user device with the application, the technique can be deployed for a connected services system without requiring any user device certification or testing. Therefore, users' devices can readily use the present connected services system as described in the present application. This unobtrusive implementation for users' devices along with the technique's ability to enforce specified access policies dynamically provides a content provider the ability to bring to market a fast and efficient solution of controlling end user access to their various content classifications. The content provider may restrict access to their content without a subscription, but allow limited access to one or more specific items of content based on a user's application state. For example, a news agency may set a policy that users are unable to access a sports section without a subscription but will allow access to one sports article if the current state of a user's application warrants access to the one sports article. However, if the user attempts to access said sports article directly from their site, the user will be denied access. However, if specified by policy from the sports content provider, the user clicks on a link to the sports article from a friend's post on a social networking application, the user would have access to read the sports article, but would not have access to other sports articles. Once the policy is determined by the content provider, the content provider does not need to communicate any changes about their resource servers, because the present technique dynamically maintains access to their resource servers based on the policy provided.

Some current systems support enforcing rules for static applications by implementing a core decision engine on a user device running the static application. The core decision engine is responsible for determining access for the static application. However, by implementing the core decision engine in this manner, the user device is prone to being compromised, or “hacked.” Once the policies are compromised, a hacker may have unfettered access to ALL resource servers, including those not associated with the said application.

In contrast, the rules coherency technique described in the present application, given that they reside in-network, makes it more challenging to be compromised. In addition, the rules coherency technique handles enforcing access policies for dynamic application and supports dynamic updates to static applications. The rules coherency technique generates a rule list in an access server and provides the rule list to the gateway server. The technique minimizes the risk of compromising the access policies and rules and if the access policies and/or rules are hacked, a patch can be quickly installed at the access server or gateway server that fixes and secures the permitted access policies.

While the foregoing written description of the invention enables one of ordinary skill to make and use an access server with a rule coherency technique described above, those of ordinary skill will understand and appreciate the existence of variations, combinations, and equivalents of the described embodiments, methods, and examples herein. Thus, the invention as claimed should therefore not be limited by the above described embodiments, methods, and examples, but by all embodiments and methods within the scope and spirit of the claimed invention.

The claimed invention is:

1. A computer-implemented method for generating network rules, the network rules being used to determine whether an application on a first network has permission to access a resource server on a second network, comprising:
generating a rule list associated with the application, the rule list being based on a state graph associated with the application, the state graph being associated with a policy and having at least two nodes and a transition, each node being associated with one out of a plurality of states of the application and the transition being associated with a change from one node and to another node, the transition reflecting a location for the resource server associated with the change from the one node to the other node;
determining access to the resource server based on the rule list.

2. The computer-implemented method of claim 1, wherein generating the rule list occurs dynamically as a user interacts with the application.

3. The computer-implemented method of claim 2, wherein the one node represents a current state and the other node represents a possible transitional state, wherein the possible transitional state is determined based on the policy and the current state.

4. The computer-implemented method of claim 3, wherein the state graph includes a plurality of nodes, the current state and the possible transitional state each being on of the plurality of nodes and additional possible transitional states being other nodes, each additional possible transition state being determined based on the policy and the current state.

5. The computer-implemented method of claim 4, wherein the possible transitional states are reflected in the rule list.

6. The computer-implemented method of claim 1, wherein the rule list comprises a transitory rule list valid for the duration of the current state and becoming invalid after transitioning from the current state.

7. The computer-implemented method of claim 1, wherein at least one of the plurality of states comprise a static state.

8. The computer-implemented method of claim 1, wherein at least one of the plurality of states comprise a dynamic state.

9. The computer-implemented method of claim 1, further comprising mapping the rule list to the policy and storing the rule list.

10. The computer-implemented method of claim 1, wherein the plurality of states comprise internal states and the state graph comprises a statically defined state graph where each of the plurality of internal states of the application has a corresponding node in the state graph.

11. A computer-implemented method for maintaining rule coherency for an application, comprising:
generating a state graph based on a policy for the application, the state graph having a plurality of nodes and at least one transition from one node to another node, where each node is associated with one out of a plurality of states of the application and the transition represents a location for an external resource server associated with the transition; and
generating a rule list based on the state graph, wherein the rule list identifies an address for a external resource server associated with each transition and specifies which of the plurality of states have permission to access the external resource server.

12. The computer-implemented method of claim 11, wherein the plurality of states comprise internal states.

13. The computer-implemented method of claim 12, wherein each of the internal states of the application are traversed until a recursive chain self-terminates, assumes an already recorded state, or the policy constrains transitioning to another state.

14. The computer-implemented method of claim 11, wherein generating the state graph occurs dynamically as a user interacts with the application.

15. A system for maintaining rule coherency for an application, said system comprising:
a memory storing computer-readable components;
a processor programmed to execute the computer-readable components; the computer-readable components comprising:
a rules update agent for generating a rule list based on a state graph associated with the application and an access policy, the state graph identifying each allowable transition form a current state, wherein the rule list includes information about each node to which a possible transitional states exists from the current state as reflected in the state graph; and
a policy server configured to send the rule list to a network gateway, the network gateway being configured to enforce access to at least one resource server based on the rule list.

16. The system of claim 15, wherein the rules update agent is further configured to update the state graph periodically.

17. The system of claim 15, wherein the rule list comprises a transitory rule list valid for a duration of a current state.

18. The system of claim 15, wherein the rule update agent is further configured to dynamically generate the rule list as a user interacts with the application.
